(19) United States
(12) Patent Application Publication
(10) Pub. No.: US 2014/0042102 A1
(43) Pub. Date: Feb. 13, 2014

(54) Front Flush Systems and Methods

(71) Applicant: WORLD WIDE WATER SOLUTIONS, Gilbert, AZ (US)

(72) Inventor: Dennis Chancellor, Gilbert, CA (US)

(73) Assignee: WORLD WIDE WATER SOLUTIONS, Gilbert, AZ (US)

(21) Appl. No.: 13/804,166

(22) Filed: Mar. 14, 2013

Related U.S. Application Data
(60) Provisional application No. 61/680,632, filed on Aug. 7, 2012.

(51) Int. Cl. B01D 29/66

(52) U.S. Cl. CPC B01D 29/66
USPC 210/741; 210/411; 210/87

(57) ABSTRACT

Systems and methods are described for flushing one or more filters using a pressurized permeate stream. The permeate stream can be pressurized within a front flush unit, which can also receive a feed water stream. Energy needed to increase the pressure of the permeate stream to a pressure sufficient to cause flushing of the filters can be generated through work exchange with the pressurized feed water stream.

This application claims priority to U.S. provisional patent application having Ser. No. 61/680632 filed Aug. 7, 2012. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is filtration systems and methods.

### BACKGROUND

To reduce the energy requirements of a reverse osmosis (RO) pump system, it is known to include a pumping system that can conserve a portion of the pressure of an incoming stream to thereby increase the pressure of a second stream. See, e.g., U.S. pat. publ. no. 2008/0296224 to Cook, et al. (publ. December 2008). However, such pumping system requires electricity to operate, which increases the overall energy use of the RO system.

To further reduce the energy requirements of filtrations systems, it is known to utilize a work exchange pump, such as that discussed in U.S. pat. publ. no. 2005/0035048 to Chancellor et al. (publ. February 2005) and U.S. Pat. No. 6,017,200 to Childs, et al. Such systems are generally complex, however, increasing their energy and maintenance costs.

Thus, there is still a need for filtration systems that further reduce energy requirements.

### SUMMARY OF THE INVENTION

The inventive subject matter provides apparatus, systems and methods in which one can reduce the energy requirements of a filtration system by utilizing an energy recovery unit fluidly coupled to the filtration system.

Preferred filtration systems include one or more filters, and preferably at least two filters, which can receive a pressurized feed water stream. As the feed water is fed into the filter, a filtered permeate stream and a reject stream are produced, which exit the filter via a permeate conduit and a reject conduit, respectively.

Such systems can also include a front flush unit configured to allow for automatic flushing of the one or more filters during operation of the system. This advantageously leads to less downtime due to maintenance. The front flush unit can be fluidly coupled to the one or more filters and configured to (a) receive at least a portion of a feed water stream and (b) produce a pressurized flushing stream that includes at least some of the permeate stream produced by the one or more filters. The pressurized flushing stream is preferably produced primarily via work exchange with the portion of the feed water stream received by the unit, which eliminates the need for additional pumps and other components and thereby reduces the overall energy cost of the system. It is especially preferred that the pressurized flushing stream is solely produced via work exchange with the portion of the feed water stream received by the unit.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of one embodiment of filtration system shown configured for normal filtration.

FIG. 2 is a schematic of the filtration system of FIG. 1 shown configured for flushing of the filters.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

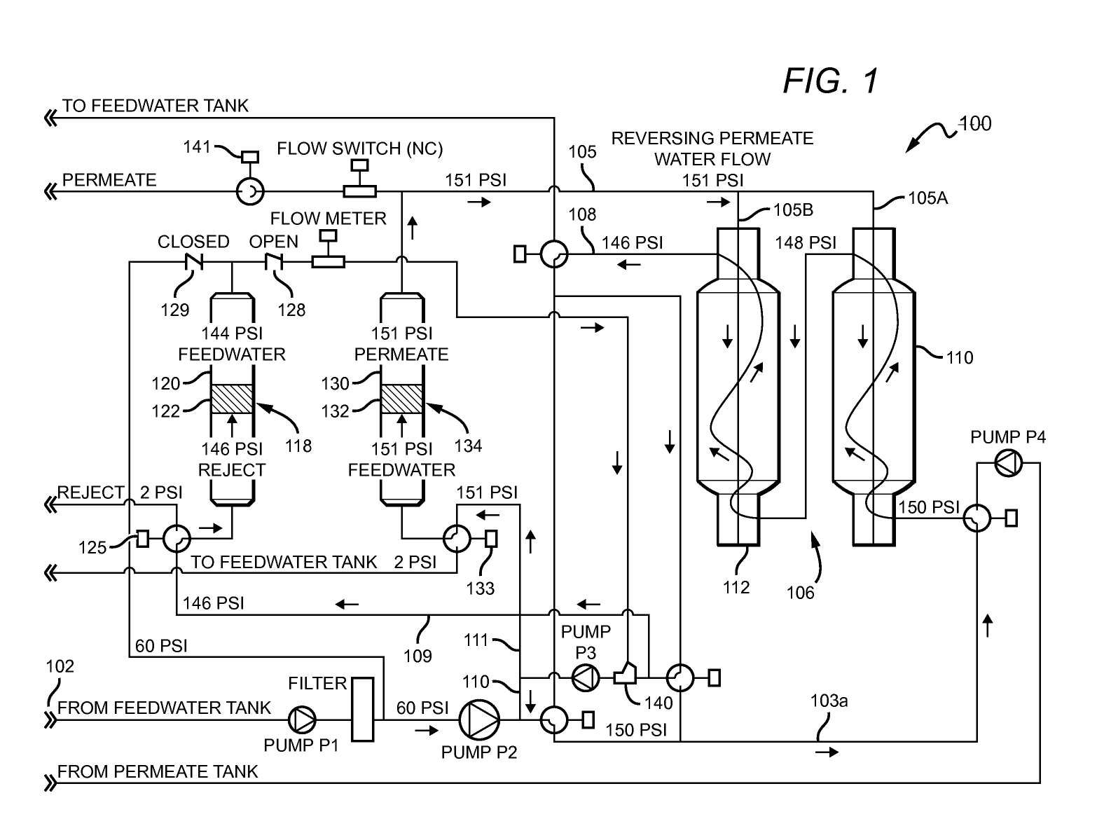

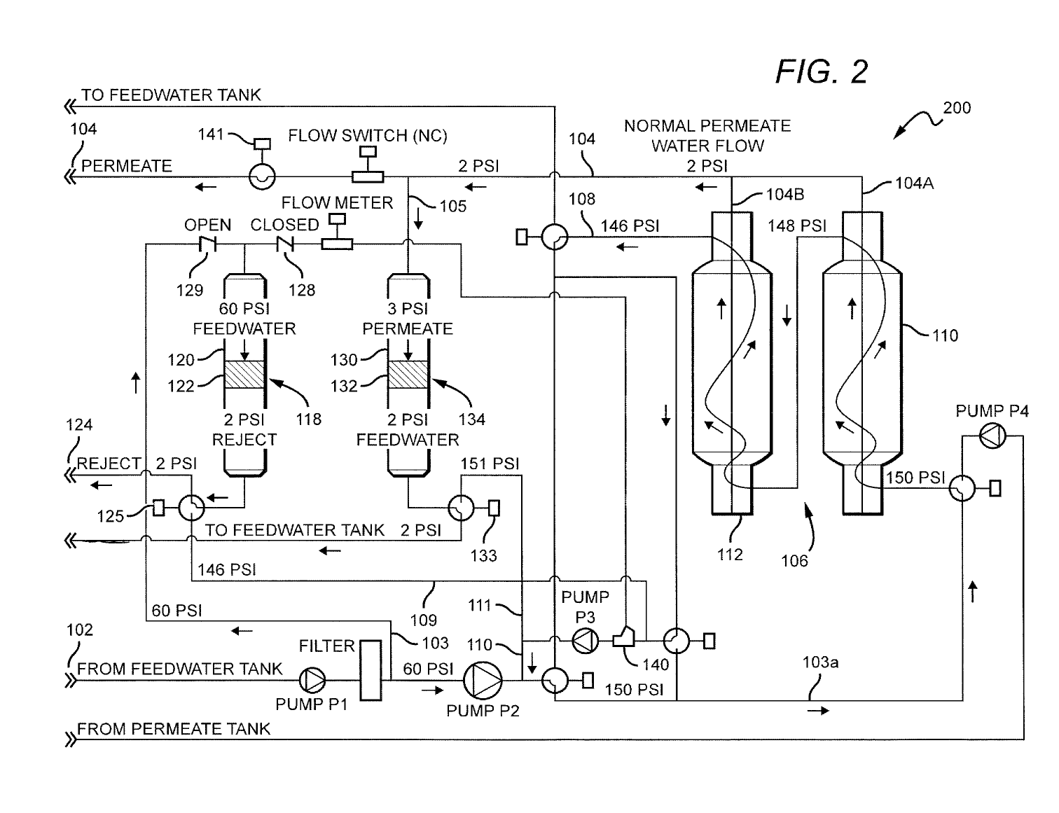

FIGS. 1-2 illustrate an embodiment of a filtration system 100 having a positive displacement pump 134 that preferably includes a cylindrical unit 130 and piston 132. The positive displacement pump 134 can be used to enable a permeate water front flush of filters 110 and 112 using at least a portion of permeate stream 104, which is designated as permeate stream 105.

Preferably, system 100 can include one or more flow sensors that are configured and disposed to monitor a flow rate of the permeate stream 104. If the one or more sensors detect that the flow rate decreases below a predetermined threshold, the one or more sensors can send one or more signals to a flow switch, for example, which can be used to alert the need to flush filters 110 and 112.

In such embodiments, it is contemplated that the system 100 can automatically close valve 141 allowing pressure to build on permeate streams 104 and 105 thereby translating piston 132 to the bottom of unit 130. When a pressure of the permeate stream 104 reaches a predetermined threshold at or near the pressure of reject stream 108, sensors can send one or more signals to a controller or valve actuator(s) to cause valve 133 to rotate, thereby inducing a portion of stream 111 feed water into pump 134. Piston 132 will translate upward and force permeate streams 104 and 105 to reverse direction. Permeate stream 105 can be separated into streams 105A and 105B, which respectively flow into the filters 110 and 112 via the permeate outlets. The back flow of permeate streams 105A and 105B advantageously can reduce build-up on the filters 110 and 112. The permeate streams 105A and 105B, build-up pressure, and reject fluid can exit the filters 110 and 112 as reject stream 108, which can then (i) exit system 200, (ii) be fed to pump P3, and/or (iii) be merged with feed water stream 103A and flowby stream 106. Contrary to prior art systems, system 200 can front flush the filters during operation of the system 200, which significantly reduces system downtime. This new front flush system may also be called an Automatic Membrane ‘Clean In Place’ Powered Up System.

In this manner, the permeate streams 104 and 105 will reverse flow through filters 110 and 112 relative to a flow direction during normal (filtration) operation of system 100. The reverse flow of permeate through the permeate collection pipes within filters 110 and 112 will facilitate the dislodging of particulate and other buildup from the membranes within filters 110 and 112 that may have reduced the flow rate of permeate stream 104.

This sequence will be reversed by rotating valve 133 to a drain position allowing pressure in permeate streams 104 and 105 to expel water from pump 134 and push piston 132 downward towards the feedwater tank, to await the next flow rate reduction of permeate stream 104. Thus, the system 200 can automatically front flush the filters 110 and 112 anytime the flow rate of permeate stream 104 is reduced below a predefined threshold.

During normal operation, system 100 can receive a feed water stream 102 that can flow past one or both of pumps P1 and P2, which thereby increase a pressure of the feed water stream 102 to approximately 150 psi, although the specific pressure can vary depending upon the application. For example, the pressure of a feed water stream comprising blackish water will likely be less than that of a feed water stream comprising salt water.

Filter 110 can receive at least a portion of feed water stream 102 and produce a permeate stream, which can then be fed into the second filter 112 to produce a second permeate stream and reject stream 108. In this manner, the feed water stream 102 can be passed through multiple filters to remove a larger percentage of impurities from the stream 102 and it is contemplated that the stream 102 could be passed serially through three or more filters although the specific number of filters will depend upon the application.

The permeate streams can optionally be merged downstream of the filters 110 and 112 as a combined stream. Optionally, a portion of the combined stream can be removed and fed into pump 134, which causes piston 132 to move downwardly, and thereby increase the pressure of, and expel, the liquid below the piston 132.

A first portion of the reject stream 108 can bypass pump P3 to increase its pressure before it is merged with the feed water stream 102 downstream of pump P2. By using a smaller pump P3 rather than pump P2 to pressurize the reject stream 108, less energy is advantageously consumed. P2 is used primarily to boost pressure of reject stream 108 and thereby recirculate reject water back into feed water 103a (i.e., P2 discharge).

As shown in the Figures, a second portion 109 of the reject stream 108 can optionally be diverted upstream of pump P3 and fed into a lower portion of a positive displacement pump 118 having a cylindrical unit 120 and piston 122. Preferably, piston 122 is a zero-buoyancy piston to reduce blowby around the piston 122 plus the pressure loss and friction between the piston 122 and unit 120.

The higher pressure reject stream 109 causes a piston 122 to translate upwardly within pump 118, which thereby expels a liquid above the piston 122 through check valve 128. The liquid can be fed into a venturi valve 140 as a result of the negative pressure created as reject stream 108 flows through the venturi valve 140. This advantageously reduces the energy costs of system 100, as the reject stream 108 does not require a pump between valve 140 and pump 118.

To reduce the amount of fluids exchanged between opposite sides of the pistons, it is preferred that the difference in pressure between the fluids on each side is less than 10 psi.

After piston 122 reaches an upper portion of pump 118, a sensor can send a signal to cause L-diverter valve 125 to be rotated to stop flow of the portion 109 of the reject stream 108 to the pump 118, as shown in FIG. 50. Although valves 128 and 129 are shown as separate valves, it is contemplated that a three-way valve could be substituted for the valves 128 and 129 to thereby further reduce the complexity of system 100. In addition, rather than use L-diverter valve 125, any commercially suitable valve(s) could be used including, for example, actuated gate valves, and ball valves. Separate valves could also be used in place of valve 125 to regulate flow into and out from the pump 118, respectively.

With valve 129 opened and valve 128 closed, the 103 portion of the feed water stream 102 can be removed upstream of pump P2 and fed into pump 118, which causes piston 122 to translate downwardly and expels a lower pressure reject stream from pump 118 through valve 125.

Preferred filters include reverse osmosis (RO) filters, and especially preferred RO filters include a filter element and a casing formed about the filter element, such as those described in U.S. utility application titled “Water Purification System With Entrained Filtration Elements” having Ser. No. 13/263819 filed on Oct. 10, 2011. As used herein, the term “filter element” is defined to include all commercially suitable filters including, for example, sand, charcoal, paper, and other media, and any membrane capable of filtering a fluid. The filter element could be of any type, size or manufacturer, and preferably the filter element is selected based upon the commercial application. Of course, any commercially suitable filter could be used without departing from the scope of the invention.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A filtration system, comprising:
a first filter configured to receive a pressurized feed water stream and produce a reject stream and a permeate stream that exits the first filter via a permeate conduit;
a front flush unit fluidly coupled to the first filter and configured to (a) receive at least a portion of a feed water stream and (b) produce a pressurized flushing stream comprising at least a portion of the permeate stream; and
wherein the pressurized flushing stream is produced via work exchange with the portion of the feed water stream received by the front flush unit.

2. The filtration system of claim 1, wherein the front flush unit comprises a positive displacement pump.

3. The filtration system of claim 2, wherein the positive displacement pump comprises a vertical cylinder having a translatable piston.

4. The filtration system of claim 3, wherein the front flush unit is further configured to receive the portion of the feed water stream in a lower portion of the unit and at least a portion of the permeate stream in an upper portion of the unit.

5. The filtration system of claim 1, further comprising a conduit fluidly coupling the front flush unit with the permeate conduit such that the pressurized flushing stream can be fed into the first filter via the permeate conduit.

6. The filtration system of claim 1, further comprising a first sensor configured to monitor a flow rate of the permeate stream and produce a first sensor signal when the flow rate is reduced at or less than a predetermined threshold.

7. The filtration system of claim 6, further comprising a controller configured to receive the first sensor signal and automatically cause actuation of one or more valves such that the portion of the feed water stream is fed into the front flush unit.

8. The filtration system of claim 6, further comprising a controller configured to receive the first sensor signal and automatically cause actuation of one or more valves such that a portion of the permeate stream is fed into the front flush unit.

9. The filtration system of claim 1, wherein the pressurized flushing stream is produced solely via energy recovered from work exchange with the portion of the feed water stream received by the front flush unit.

10. The filtration system of claim 1, wherein a pressure of the portion of the feed water stream entering the front flush unit is about 151 psi, and a pressure of the portion of the permeate stream is about 2 psi.

11. The filtration system of claim 1, wherein the permeate stream enters the front flush unit at a pressure of less than 10 psi, and wherein the pressurized flushing stream that includes at least the portion of the permeate stream exits the front flush unit at a pressure of about 151 psi as a function of the work exchange.

12. A method for automatically flushing one or more filters using a permeate stream, comprising:
providing a front flush unit configured to receive a feed water stream and a permeate stream;
wherein the front flush unit is configured to increase a pressure of the permeate stream through work exchange with the feed water stream to produce a pressurized permeate stream; and
automatically flushing a first filter using the pressurized permeate stream when a flow rate of the permeate stream is less than a predetermined threshold.

13. The method of claim 12, wherein the first filter receives at least a portion of the feed water stream and produces the permeate stream received by the front flush unit.

14. The method of claim 12, wherein the front flush unit comprises a positive displacement pump.

15. The method of claim 14, wherein the positive displacement pump comprises a vertical cylinder having a translatable piston.

16. The method of claim 12, further comprising monitoring a flow rate of the permeate stream from the first filter using a first sensor configured to produce a first sensor signal when the flow rate is less than the predetermined threshold.

17. The method of claim 12, further comprising actuating one or more valves using a controller as a function of the first sensor signal, such that the feed water stream is fed into the front flush unit.

18. The method of claim 12, further comprising actuating one or more valves using a controller as a function of the first sensor signal, such that the permeate stream is fed into the front flush unit.

19. The method of claim 12, wherein the pressurized permeate stream is produced solely via energy recovered from work exchange with the feed water stream in the front flush unit.

20. The method of claim 12, wherein the permeate stream enters the front flush unit at a pressure of less than 10 psi, and wherein the pressurized permeate stream exits the front flush unit at a pressure of about 151 psi as a function of the work exchange.
